(19) United States
(12) Patent Application Publication
(10) Pub. No.: US 2025/0010407 A1
(43) Pub. Date: Jan. 9, 2025

(54) INSPECTION METHOD

(71) Applicant: TOYOTA JIDOSHA KABUSHIKI KAISHA, Toyota-shi (JP)

(72) Inventors: Nao KAWABE, Chiba-shi (JP); Tomohiko SEKIGUCHI, Nagakute-shi (JP); Toru HIOKI, Nisshin-shi (JP); Tomoko OGASAHARA, Nagoya-shi (JP); Shota EJIMA, Nagoya-shi (JP); Takaya OBARA, Toyota-shi (JP)

(73) Assignee: TOYOTA JIDOSHA KABUSHIKI KAISHA, Toyota-shi (JP)

(21) Appl. No.: 18/756,841

(22) Filed: Jun. 27, 2024

(30) Foreign Application Priority Data
Jul. 6, 2023 (JP) 2023-111441

(51) Int. Cl. B23K 31/12; B23K 11/11; B23K 101/18; B23K 103/04; G01B 7/16

(52) U.S. Cl. CPC B23K 31/125; B23K 11/115; G01B 7/16; B23K 2101/18; B23K 2103/04

(57) ABSTRACT

To provide an inspection method by which a poorly-welded workpiece can be discriminated with high accuracy even under the presence of disturbances. According to the present disclosure, an inspection method for spot welding in which an electrical current is applied to electrodes that sandwich steel plates includes: calculating a contraction amount of the steel plates at the electrodes from a welding force and an inter-electrode displacement amount after the end of application of the electrical current to the electrodes, and determining that the spot welding is poor when the contraction amount is equal to or below a discrimination threshold.

### CROSS REFERENCE TO RELATED APPLICATIONS

This application is based upon and claims the benefit of priority from Japanese patent application No. 2023-111441, filed on Jul. 6, 2023, the disclosure of which is incorporated herein in its entirety by reference.

### BACKGROUND

The present disclosure relates to an inspection method, in particular, to an inspection method for spot welding.

Patent Literature 1 (International Patent Publication No. WO 2016/174842) discloses a welding method for weld-joining superimposed steel plates to each other using spot welding.

### SUMMARY

Patent Literature 1 discloses that in performing weld-joining steel sheets using spot welding, welding is performed on the basis of a time variation curve of instantaneous heating value per unit volume per step and cumulative heating value stored as a target value in test welding.

Patent Literature 1 also discloses that when the time variation of instantaneous heating value per unit volume deviates from the time variation curve serving as the reference due to the occurrence of scattering in any step, the amount of deviation is compensated within the remaining electrical current application time in that step. In addition, Patent Literature 1 discloses that electrical current application amount is controlled so that the cumulative heating value in the present welding matches the cumulative heating value in the test welding, and if occurrence of scattering is detected in any step, the target value of the cumulative heating value thereafter is reduced.

Patent Literature 1 discloses that control to set and correct a discrimination threshold for determining an abnormal value of the cumulative heating value after scattering occurs, and this method is also used in the inspection method by which poor welding is discriminated. On the other hand, it is difficult to set a discrimination threshold for determining an abnormal value because the interference from the outside to the operation of the manufacturing equipment is large, that is, regarding a workpiece exposed to a large disturbance, an expansion amount of the workpiece during application of an electrical current fluctuates according to the strength of the disturbance.

The present disclosure is made to solve such a problem mentioned above, and an object of the present disclosure is to provide an inspection method by which a poorly-welded workpiece can be discriminated with high accuracy even under the presence of disturbances.

According to the present disclosure, an inspection method for spot welding in which an electrical current is applied to electrodes that sandwich steel plates, includes: calculating a contraction amount of the steel plates at the electrodes from a welding force and an inter-electrode displacement amount after the end of application of the electrical current to the electrodes, and determining that the spot welding is poor when the contraction amount is equal to or below a discrimination threshold. Thus, it is possible to provide an inspection method by which a poorly-welded workpiece can be discriminated with high accuracy.

Further, expansion amounts of the steel plates are calculated at the electrodes from the welding force and time variation of the inter-electrode displacement amount from the start of the application of the electrical current to the electrodes to the end of the application of the electrical current to the electrodes, and the contraction amount is calculated from the difference between the maximum value and the minimum value of the expansion amounts. In this way, it is possible to provide an inspection method by which a poorly-welded workpiece can be discriminated even in the presence of disturbances.

With the present disclosure, it is possible to provide an inspection method by which a poorly-welded workpiece can be discriminated with high accuracy even in the presence of disturbances.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1A is a schematic diagram illustrating spot welding according to the present embodiment;

FIG. 1B is a schematic diagram illustrating spot welding according to the present embodiment;

FIG. 1C is a schematic diagram illustrating spot welding according to the present embodiment;

FIG. 2A is a waveform showing expansion/contraction of nuggets according to the present embodiment;

FIG. 2B shows cross-sectional views of sample workpieces that have been subjected to spot welding;

FIG. 3 is a diagram illustrating determination of a poorly-welded workpiece performed according to the present embodiment;

FIG. 4A is a diagram illustrating spot welding that is performed in the presence of disturbances according to the present embodiment;

FIG. 4B is a diagram illustrating spot welding that is performed in the presence of disturbances according to the present embodiment;

FIG. 4C is a diagram illustrating spot welding that is performed in the presence of disturbances according to the present embodiment;

FIG. 5A is a diagram illustrating determination of a poor-welded workpiece that is performed in the presence of disturbances according to the present embodiment; and

FIG. 5B is a diagram illustrating determination of a poorly-welded workpiece that is performed in the presence of disturbances according to the present embodiment.

### DESCRIPTION OF EMBODIMENTS

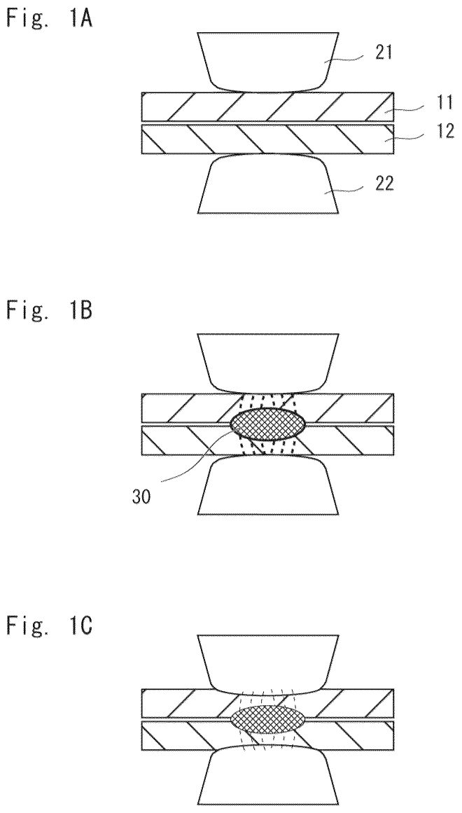

The present disclosure will now be described with reference to the drawings. FIGS. 1A to 1C are schematic diagrams illustrating spot welding according to the present disclosure.

In spot welding, superimposed steel plates 11 and 12 are sandwiched by a pair of electrodes 21 and 22 (see FIG. 1A), and a nugget 30 is formed by applying electrical current while applying pressure, whereby the steel plates are weld-joined (see, FIG. 1B). When application of an electrical current is started, the nugget 30 starts to expand, and due to increase in the electrical resistance, the temperature rises and the area of the electrodes to which electrical current is applied is extended. When application of the electrical current is ended, the nugget 30 shrinks and electrical resistance decreases, and due to the shrinkage, a part of the electrodes 21 and 22 sinks into the steel plates 11 and 12 (see FIG. 1C).

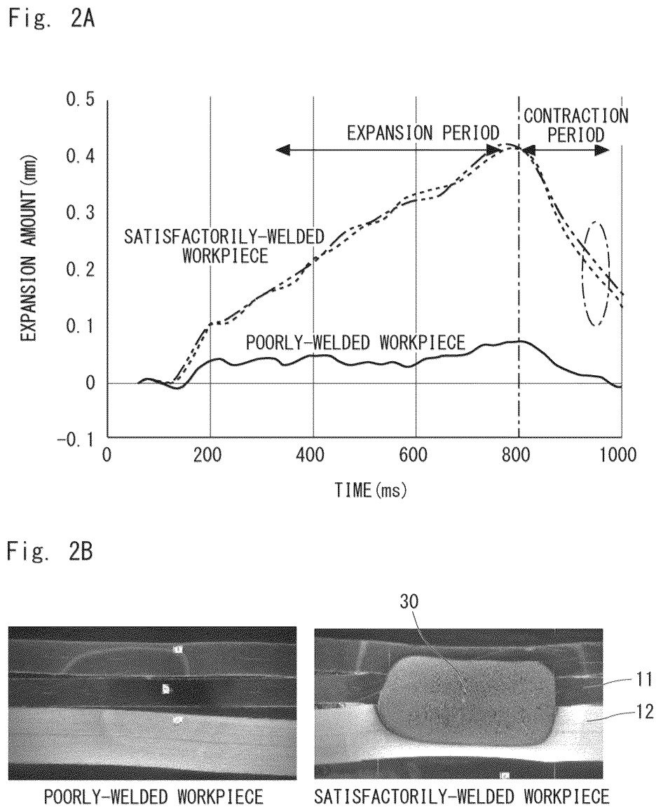

FIG. 2A shows the expansion/contraction amount of the steel plates 11 and 12, especially the expansion/contraction amount of the nugget 30 during spot welding, i.e., from the start of application of an electrical current to the end of application of the electrical current, taken from a welding force and measured value of an inter-electrode displacement amount of the electrodes 21 and 22, and having the time variation thereof plotted. Further, FIG. 2B shows cross-sectional views of a satisfactorily-welded sample workpiece and a poorly-welded sample workpiece that have been subjected to spot welding. In an expansion period during which electrical current is applied, the nugget 30 expands between the steel plates 11 and 12, and the nugget 30 contracts in the contraction period during which application of an electrical current is ended and the temperature decreases. At this time, the sample workpiece in which the nugget 30 is properly expanded is discriminated as a satisfactorily-welded workpiece. On the other hand, the sample workpiece in which the nugget 30 is hardly expanded or the nugget 30 is not formed is discriminated as a poorly-welded workpiece. Thus, a satisfactorily-welded workpiece has a feature in which the nugget 30 is greatly expanded compared with a poorly-welded workpiece.

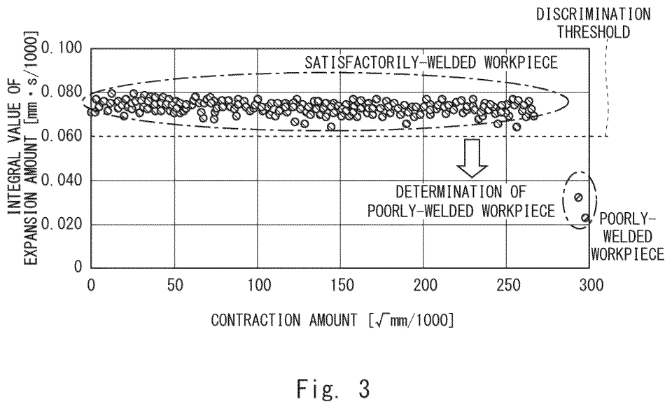

FIG. 3 shows a result of calculation of integral values of the expansion amounts in the expansion period for a large number of sample workpieces, and the integral values are plotted on the vertical axis (unit: mm·s/1000) and the contraction amounts, which are the difference between the maximum and the minimum values of the expansion amounts of the sample workpieces in the expansion period in which calculation of the contraction amounts of the sample workpieces was performed, are plotted on the horizontal axis (unit: √mm/1000). Note that the division of the integral value and the contraction amount by 1000 in FIG. 3 was performed to adjust the number of digits for purpose of managing the sample workpieces, and is not an essential process. It can be seen that there is a clear difference in the integral value of the expansion amounts between the sample workpiece which is a satisfactorily-welded workpiece in which the nugget 30 is appropriately expanded and the sample workpiece which is a poorly-welded workpiece in which the nugget 30 is hardly expanded, and that there is little variation in the integral value of the expansion amounts of the sample workpieces which are satisfactorily-welded workpieces.

Therefore, it is possible to discriminate a poorly-welded workpiece by using an integral value of the expansion amounts as discrimination parameters and setting a discrimination threshold for the discrimination parameters. The standard deviation σ of the variation in the satisfactorily-welded workpieces is used in setting a discrimination threshold, and for example, in FIG. 3, a discrimination threshold value is set to be around 0.060, which is 5σ, and the sample workpieces whose discrimination thresholds are below this discrimination threshold are determined to be poorly-welded workpieces.

Thus, the inspection method by which poor-welding is discriminated using an abnormal value of an integral value of the expansion amounts can be employed, in particular, in a manufacturing process to inspect poor welding, i.e., an in-process.

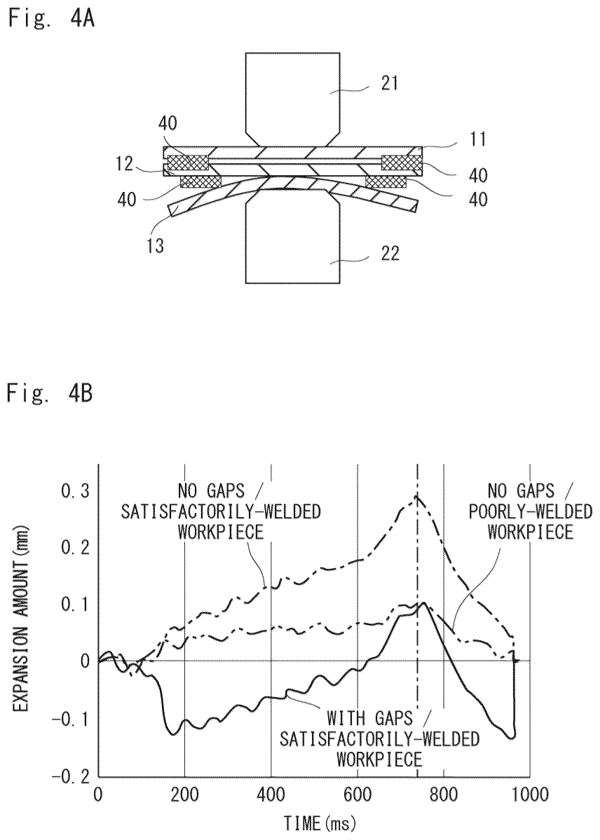

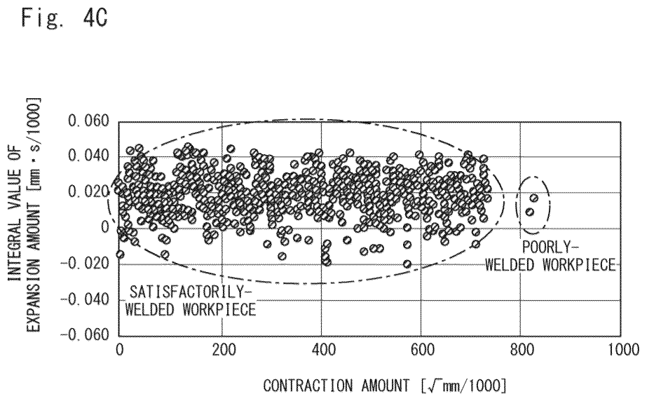

Next, as an example of spot welding in which disturbances occurred in the process of the spot welding, the case where hard gaps are formed between the steel plates will be described with reference to FIGS. 4A to 4C. FIG. 4A shows, as an example, spot welding performed in a state where a plurality of gaps 40 are formed between three steel plates 11, 12 and 13.

If the gaps 40 are soft, the gaps can be crushed when the steel plates 11, 12 and 13 are superimposed. However, if the gaps 40 are hard, the gaps 40 cannot be completely crushed whereby a flow diversion occurs around the electrodes, causing the steel plates 11, 12 and 13 to soften then the gaps 40 to collapse. When the expansion/contraction amount of the nugget of such a sample workpiece is plotted as shown in FIG. 4B, it is seen that expansion starts after the expansion amount first drops immediately after the application of an electrical current, as shown by the solid line in FIG. 4B. Therefore, the waveform illustrating the expansion period is significantly changed, such as having a negative expansion amount, compared with that illustrating the normal state.

In addition, since the degree of decline in the expansion amount immediately after the application of the electrical current varies depending on the number of gaps 40 and the degree of collapse thereof, the plotted expansion amount of the sample workpiece in which the gaps 40 are formed between the plates is much more variable than the plotted expansion amounts of the sample workpiece in which no gaps 40 are formed.

In FIG. 4C, the integral value of the expansion amounts in the expansion period at this time is shown on the vertical axis and the contraction amount, which is the difference between the maximum value and the minimum value of the expansion amounts in the expansion period in which calculation of the contraction amounts of the sample workpieces was performed, is shown on the horizontal axis. The calculation of the integral values of the expansion amounts and the contraction amounts are the same as those in FIG. 3. Since there are many variations in the plotted expansion amounts for the sample workpiece in which the gaps 40 are formed, there are also many variations in the integral values of the expansion amounts. Moreover, since there is no clear difference between the integral value of the expansion amount for a satisfactorily-welded workpiece and that for a poorly-welded workpiece, it becomes difficult to set integral values of the expansion amounts as discriminate parameters and discriminate a poorly-welded workpiece from a satisfactorily-welded workpiece by setting a discrimination threshold based on the standard deviation σ of the variation of satisfactorily-welded workpieces. Thus, the waveform illustrating the expansion period shown in FIG. 4B is greatly influenced by the disturbances. On the other hand, inventors of the present disclosure found that the influence of the disturbances on the contraction period after the end of the application of the electrical current was small.

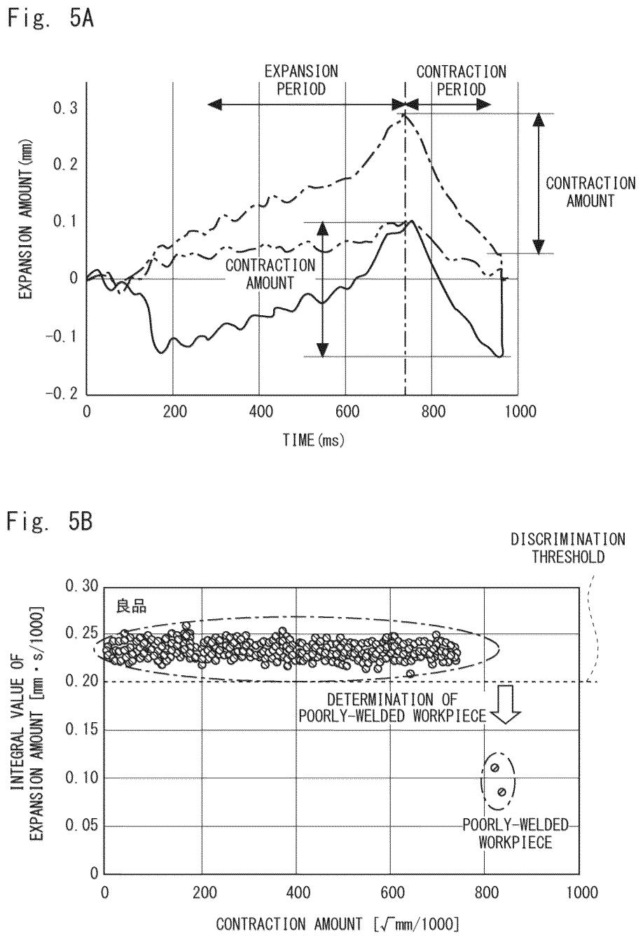

The aforementioned point is used to set the difference between the maximum value and the minimum value in the contraction period as a contraction amount, and this contraction amount is used as discrimination parameters, as shown in FIG. 5A. FIG. 5B shows a contraction amount in an expansion period calculated for a large number of sample workpieces, with the integral values of the expansion amounts shown on the vertical axis, and the contraction amount, which is the difference between the maximum and minimum values of the expansion amounts of the sample workpieces in the expansion period in which calculation of the contraction amounts of the sample workpieces was performed, plotted on the horizontal axis. The calculation of the integral values of the expansion amounts and the contraction amounts are the same as those in FIG. 3. It can be understood from FIG. 5B that even in the presence of disturbances, such as formation of the gaps 40, there is a clear difference between the contraction amount for the sample workpieces which are satisfactorily-welded workpieces and that for the sample workpieces which are poorly-welded workpieces, and that a variation in the contraction amount for the sample workpieces which are satisfactorily-welded workpieces is small. Therefore, it is possible to set a discrimination threshold by which a poorly-welded workpiece can be clearly discriminated from a satisfactorily-welded workpiece by using the standard deviation σ of the variation of satisfactorily-welded workpieces.

In this way, it is possible to provide an inspection method by which a poorly-welded workpiece can be discriminated with high accuracy even in the presence of disturbances.

It should be noted that the present disclosure is not limited to the above embodiments, and can be suitably changed to the extent that it does not deviate from the scope of the present disclosure.

What is claimed is:

1. An inspection method for spot welding in which an electrical current is applied to electrodes that sandwich steel plates, the method comprising:
calculating a contraction amount of the steel plates at the electrodes from a welding force and an inter-electrode displacement amount after the end of application of the electrical current to the electrodes; and
determining that the spot welding is poor when the contraction amount is equal to or below a discrimination threshold.

2. The inspection method according to claim 1, wherein
expansion amounts of the steel plates are calculated at the electrodes from the welding force and time variation of the inter-electrode displacement amount from the start of the application of the electrical current to the electrodes to the end of the application of the electrical current to the electrodes, and
the contraction amount is calculated from the difference between the maximum value and the minimum value of the expansion amounts.
